(19) United States
(12) Patent Application Publication
(10) Pub. No.: US 2025/0180408 A1
(43) Pub. Date: Jun. 5, 2025

(54) THERMAL ANOMALY MANAGEMENT

(71) Applicant: EATON INTELLIGENT POWER LIMITED, Dublin 4 (IE)

(72) Inventors: Catriona CLARKE, Newbridge, Kildare (IE); Saiful HAQ, Uttarpradesh, Mahanagar,Lucknow (IN); Fiaz SHAIK, Dublin (IE); Sachin RANE, Pune (IN)

(21) Appl. No.: 18/838,682

(22) PCT Filed: Apr. 20, 2022
(86) PCT No.: PCT/EP2022/025161

§ 371 Date: Aug. 15, 2024

(30) Foreign Application Priority Data
Feb. 16, 2022 (IN) 202211008245

(51) Int. Cl. G01K 1/02; G06N 3/09

(52) U.S. Cl. CPC G01K 1/026; G06N 3/09

(57) ABSTRACT

Some embodiments relate to a method of managing thermal anomalies in an environment is described. A deep learning system is trained to identify thermal anomalies from recorded environment parameter data. A Bayesian network is also trained to identify relationships between environment parameters, and the identified relationships are used to develop a causal explanation hierarchy. Using these trained systems, environment parameters are measured first to identify a thermal anomaly, and on identification of a thermal anomaly, and then to provide a causal explanation hierarchy for the thermal anomaly. This enables a real-world intervention to address the thermal anomaly. A suitable system to perform this method is also described.

### TECHNICAL FIELD

The disclosure relates to thermal anomaly management. Embodiments relate particularly to the detection and interpretation of thermal anomalies in environments with high densities of electrical and electronic apparatus, such as data centres.

### BACKGROUND TO DISCLOSURE

Thermal management in physical environments containing significant amounts of electronic and electrical apparatus may be challenging, as such apparatus generates significant amounts of heat and may malfunction or create safety risks if temperature moves outside a safe range. Cooling is necessary, but it adds to cost and will typically lead to further heat generation, which itself requires management. In a data centre environment, for example, a careful balance between heating from operation of computing equipment and cooling is required.

The temperature distribution in a data centre is determined by local imbalances between heat generation (typically primarily by servers) and heat extraction (typically by CRAC—computer room air conditioning—and CRAH—computer room air handling—systems). While the system will be set up to balance these, there are a number of ways in which a local imbalance between the two may result, such as the following:
cyber attacks on either the computing or cooling infrastructure
CRAC or CRAH unit failures
server fan failures
misconfiguration of computing or cooling systems

Any of the above may cause, over time, an unexpected large heat imbalance resulting in a significant temperature change and, hence unexpected thermal anomalies. Thermal anomalies might lead to system operation in unsafe temperature regions. This can lead to accelerated degradation of servers or other apparatus—this can lead to reduced effectiveness and hence reduced productivity, unplanned down time, and safety issues. It is therefore important to identify and diagnose thermal anomalies in real time to take appropriate corrective actions before problems result.

Identifying, localizing and finding the root cause of thermal anomalies is challenging for a number of reasons:
The monitored variables in a data centre can have varying formats and structures—these may consist of both temporally varying data (e.g. temperature sensor readings) as well as constant data (e.g. location of the sensors).
Both temporal and constant data may be continuous (e.g., age of component, temperature, voltage, current, etc.) or discrete (e.g., state of component, warnings and alarms, etc.).
   These may have very different individual-variable (e.g., seasonality, trend, etc.) and multi-variable patterns (e.g., correlation relationships, causal relationships, etc.).
A data centre will operate across a day and across a year, and it may experience different environmental conditions at different times-such variation in environmental conditions may lead in itself to different patterns of thermal variation in the data centre.
Existing methods rely on earlier understood physical relationships between variables which might lead to false causal models if this understanding is incorrect or incomplete. Generally, identifying causal relationships requires significant domain expertise.

Conventional approaches are dominated by use of thermal mapping (see for example Eun Kyung Lee, Hariharasudhan Viswathan and Dario Pompili, “Model-based Thermal Anomaly Detection in Cloud Datacenters” in 2013 IEE International Conference on Distributed Computing in Sensor Systems) with modelling used to understand server and cooling system behaviour (see for example Charley Chen, Guosai Wang, Jiao Sun and Wei Xu, “Detecting Data Center Cooling Problems Using a Data-driven Approach” from APSys'18, Jeju, South Korea. Such approaches, informed by best practice in the area (see for example “Data Center Power Equipment Thermal Guidelines and Best Practices”, a white paper from ASHRAE Technical Committee (TC) 9.9 Mission Critical Facilities, Data Centers, Technology Spaces, and Electronic Equipment) go some way to providing effective anomaly recognition but are reliant on specific models proving accurate predictors of real-world data centre behaviour.

It would be desirable to overcome some or all of these challenges to achieve an effective way of detecting, diagnosing, and so managing thermal anomalies in environments such as a data centre containing significant quantities of electrical and electronic apparatus.

### SUMMARY OF DISCLOSURE

In a first aspect, the disclosure provides a computer-implemented method of managing thermal anomalies in an environment, the method comprising: training a deep learning system to identify thermal anomalies from recorded environment parameter data; training a Bayesian network to identify relationships between environment parameters, and developing a causal explanation hierarchy from the identified relationships; and measuring environment parameters in the environment to identify a thermal anomaly, and on identification of a thermal anomaly; providing a causal explanation hierarchy for the thermal anomaly to enable a real-world intervention to address the thermal anomaly.

This approach enables thermal anomalies to be identified and addressed effectively without requiring detailed domain knowledge by a user.

In embodiments, the environmental parameters may be of multiple parameter types. Such multiple parameter types may include thermal measurements in the environment and at least one more parameter type. This goes beyond the traditional approach to thermal anomaly detection and management, as it does not simply rely on thermal maps for anomaly detection. Such a parameter type may comprise one or more of cooling equipment status, cooling equipment performance and power usage in the environment. Some of these environmental parameters comprise one or more parameters with temporal cyclicity—in such cases, the parameters may be represented by a time varying sequence of values. Such sequences may be determined using an autocorrelation function, typically in a data cleansing and preparation activity before training of models.

In embodiments, a performance optimization stage is provided between identification of a thermal anomaly and providing a causal explanation of the anomaly so that only necessary environment parameter data is used to provide the causal explanation. Such a performance optimization stage is performed both before training of the Bayesian network and development of the causal explanation hierarchy and before providing a causal explanation hierarchy for a detected thermal anomaly.

The deep learning system may comprise one or more neural networks—it may comprise an autoencoder, a variational autoencoder, or a generative adversarial network.

In embodiments, an alert is provided on detection of a thermal anomaly. This alert may be provided with the causal explanation hierarchy for the detected thermal anomaly to one or more recipients by a network connection.

The environment may be a data centre or a server room. In such a case, the at least one more parameter type may comprise server load and/or server performance.

In a second aspect, the disclosure provides a thermal anomaly management system for managing thermal anomalies in an environment comprising: means to receive environment parameter data for a plurality of environment parameters for the environment; a computing system having at least one memory and a processor programmed to provide at least: a deep learning system trained from recorded environment parameter data to identify thermal anomalies; a Bayesian network trained to identify relationships between environment parameters; and a causal explanation hierarchy for detected thermal anomalies derived from the trained Bayesian network to enable a real-world intervention to address the thermal anomaly.

The means to receive environment parameter data may comprise a plurality of sensors in the environment. This plurality of sensors may comprise temperature sensors.

In embodiments, the environmental parameters may be of multiple parameter types, including thermal measurements in the environment and at least one more parameter type. In this case, the at least one more parameter type may comprise one or more of cooling equipment status, cooling equipment performance and power usage in the environment.

In embodiments, the computing system may further comprise a performance optimization stage between identification of a thermal anomaly and providing a causal explanation of the anomaly adapted so that only necessary environment parameter data need be used to provide the causal explanation

In embodiments, the deep learning system may comprise one or more neural networks. Such a deep learning system comprises an autoencoder, a variational autoencoder, or a generative adversarial network.

In embodiments, the thermal anomaly management system may further comprise an alerting system for providing an alert on detection of a thermal anomaly. This alerting system may be adapted to provide the alert with the causal explanation hierarchy for the detected thermal anomaly to one or more recipients by a network connection.

In embodiments, the environment may be a data centre or a server room.

### BRIEF DESCRIPTION OF FIGURES

Embodiments of the disclosure will now be described, by way of example, with reference to the following figures, of which:

FIG. 1 shows a system implementing an embodiment of the disclosure for thermal management in a data centre;

FIG. 2 shows an approach to training a deep learning model for recognition of thermal anomalies according to an embodiment of the disclosure;

FIG. 3 shows an approach to testing the deep learning model of FIG. 2 to determine whether it is effective for use;

FIG. 4 provides a representation of the results at different stages of the testing shown in FIG. 3;

FIG. 5 illustrates a process of performance optimization to allow effective root cause analysis of a flagged anomaly according to an embodiment of the disclosure;

FIG. 6 illustrates a root cause analysis model for an anomaly using a Bayesian network in accordance with an embodiment of the disclosure;

FIG. 7 shows an exemplary Bayesian network learned using data available in respect of a multivariate anomaly detected due to clogging of a server inlet; and

FIG. 8 shows the causal explanation tree following from the Bayesian network of FIG. 7;

FIG. 9 illustrates a deep learning model based on a neural network;

FIG. 10 illustrates the approach to deep learning taken by an autoencoder-type models, with

FIGS. 11A and 11B illustrating the different approaches taken in autoencoders and variational autoencoders respectively;

FIG. 12 illustrates the approach to deep learning taken by a generative adversarial network (GAN); and

FIG. 13 illustrates in general terms steps of a method according to an embodiment of the disclosure.

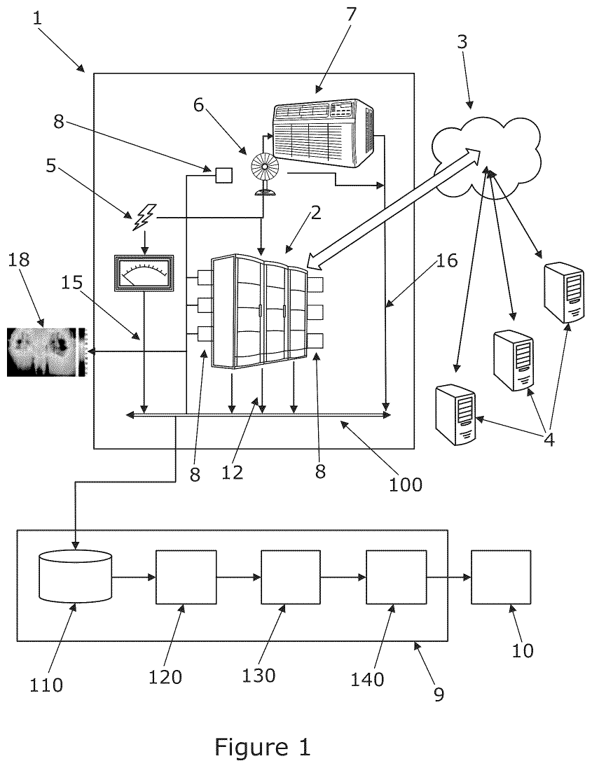

FIG. 1 shows a system implementing an embodiment of the disclosure for thermal management in a data centre. The data centre 1 contains a number of servers 2 which are here providing cloud-based services over a network 3 to remote computers 4. The servers 2 are powered from an electrical supply 5 and are supported in this case by two types of cooling and air flow elements—server fans 6 and a computer room air handling system 7.

A number of types of thermally related data are obtainable from the data centre. Energy consumption data 15 can be obtained from the energy source 5, and individual server load performance data 12 obtained from the servers, which can be used to provide information about heat generation (and its location) in the data centre. Cooling system performance data 16 can be obtained from the server fans 6 and the computer room air handling system 7. Temperature can be measured directly by thermocouples 8 distributed appropriately throughout the data centre. The traditional approach to detecting thermal anomalies would be to use a thermal map 18 essentially provided by temperature data from thermocouples 8.

FIG. 1 shows how analytics engine 9 is used to provide a more effective way of detecting thermal anomalies. The analytics engine 9 may be realised by an on-site server or by other means, such as by one or more cloud-based services. The output of the analytics engine 9 goes to an alerting system 10 for taking appropriate actions (for example, messaging alerts to responsible staff, activation of intervention systems) if a thermal anomaly requiring action is detected.

The elements of the analytics engine 9 are as follows. Data from the computer room systems 100 is sent to a data warehouse 110, where it is aggregated appropriately for use in analysis and stored while it is useful. The next stage of the analytics engine is the anomaly detection engine 120—this is a machine learning system which can be used as a detection algorithm after training, as will be described further below. A variety of models are appropriate to multivariate anomaly detection of this type—suitable but non-limiting examples are an autoencoder or a variational autoencoder, or a generative adversarial network. Output from the trained anomaly detection engine 120 is passed to a performance optimisation module 130—this limits the data for further analysis to that necessary to identify its cause by eliminating data from sensors unconnected to the anomaly or providing redundant output (for example, through spatial proximity). This selected anomaly-related data is passed to a root cause analysis engine 140—as described further below, this uses a Bayesian network, again after training, to evaluate data from isolated sensors or groups of sensors to determine a root cause of the thermal anomaly, and so to provide appropriate output to the alerting system 10.

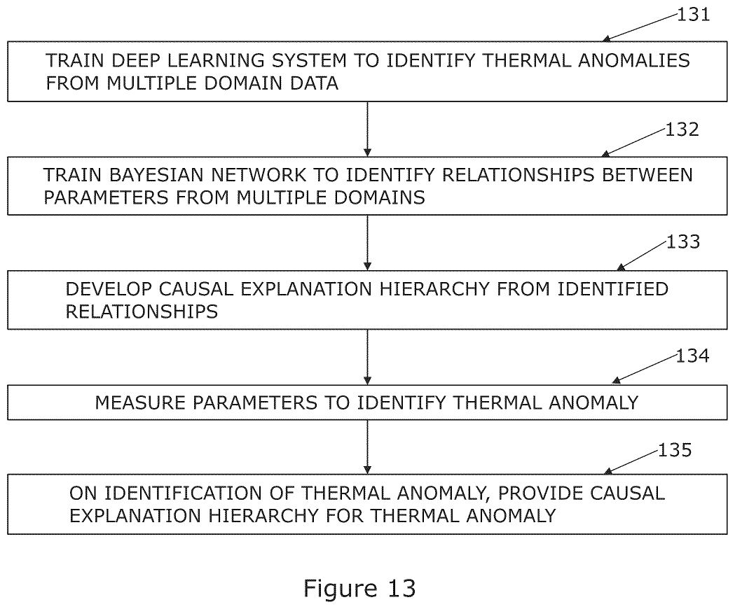

The general method taken by the analytics engine 9 is shown in FIG. 13. First of all, a deep learning system is trained 131 to identify thermal anomalies—this is done using data from multiple domains (and not simply from temperature sensors). A Bayesian network is then trained to identify 132 relationships between parameters, where these parameters are again from multiple domains—this is used to develop 133 a causal explanation hierarchy from the identified relationships. In use, parameters are measured to identify 134 a thermal anomaly, using the trained deep learning system. When the thermal anomaly has been identified, the causal explanation hierarchy is used 135 to establish possible causes of the thermal anomaly, preferably from most to least likely. These can then be provided—typically with an alert—to allow a user intervention to address the thermal anomaly, but in such a way as to allow an informed intervention most likely to address the anomaly in the most effective manner.

The functionality of each element of the analytics engine 9 will now be described in more detail, along with the methods of training and of operation of these different elements.

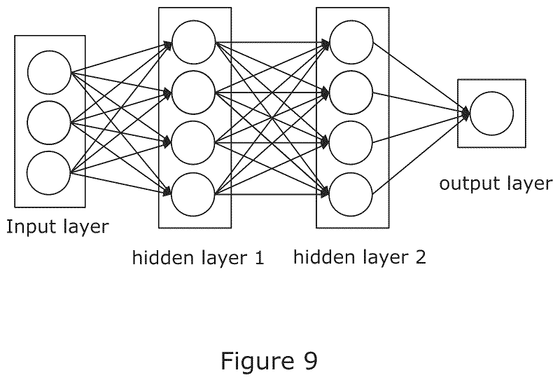

The anomaly detection engine 120 is here based upon a deep learning model. As shown in FIG. 9, deep learning models are typically neural network based—a series of interconnected “neurons” form the neural network (NN). These Neural Networks are analogous to a circuit board, where the architecture and the connections are designed before model training begins. During training, the values of the “circuit components” (neuron weights) are modified in such a way that the neural network can accomplish the task it was designed for.

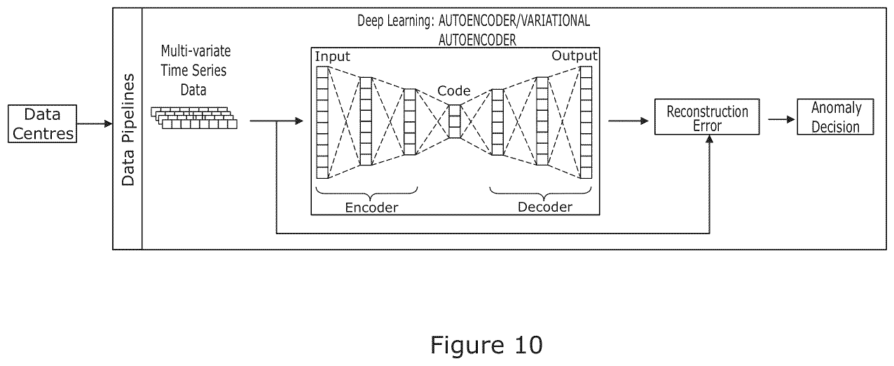

Here, an unsupervised deep learning based model is utilized. Embodiments of the disclosure may use any of a number of deep-learning based models using a variety of techniques—for example, one or a combination of any of the following deep-learning based approaches may be used: Autoencoder (AE), Variational Autoencoder (VAE) or Generative Adversarial Networks (GAN). Each of these utilize a combination of Recurrent (NN layer that learns temporal patterns) and Convolution (NN layer that learns non-temporal patterns) neural network layers. These different approaches are illustrated in FIGS. 10 to 12.

Autoencoders (AE), Variational Autoencoders (VAE) and GANs are all types of unsupervised artificial neural network that learn how to recreate outputs from a set of inputs. This is done by an encoder/decoder architecture for an Autoencoder, and by a generator/discriminator architecture for a GAN.

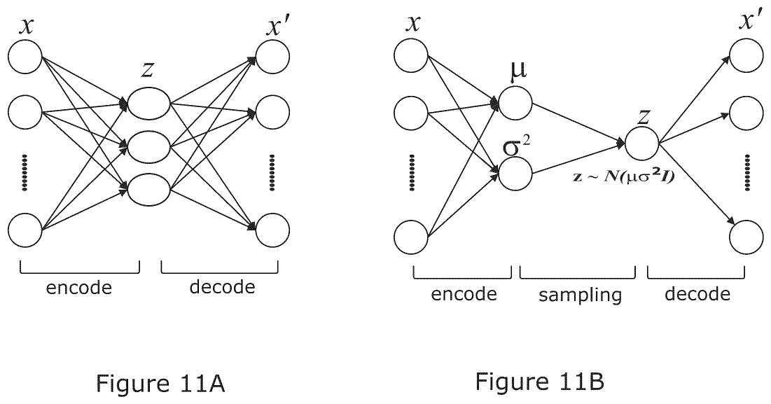

For an AE or VAE, the encoder compresses the input data, and the decoder attempts to recreate the original from the encoded compressed data—this is shown generally in FIG. 10. The difference between AE and VAE is that an AE learns a single value “compressed representation” of the input data, whereas a VAE learns the parameters of a probability distribution representing the input data, and then samples from the distribution to get the “compressed representation” of the input data. This distinction is illustrated in FIGS. 11A and 11B respectively.

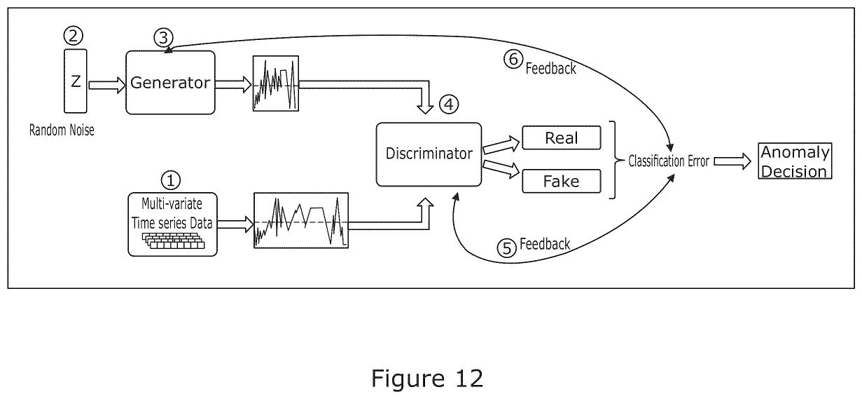

For a GAN, the generator generates an output from random data, and the discriminator then tries to determine if the output from the generator is real or fake by comparing the output with real data. Loss feedback is then sent until the discriminator is unable to determine fake data from real data. This process is shown in FIG. 12.

These processes force the AE, VAE and GAN to learn the underlying useful properties of the data. For anomaly detection, the deep learning system learns the representation of “normal data”, and when the trained system cannot faithfully reconstruct data that it receives using this representation, the received data can be interpreted as an anomaly. This is shown in FIG. 10 for an autoencoder—the initial data cannot be reconstructed—and in FIG. 12 for a GAN—the received data can be discriminated from known “normal data”.

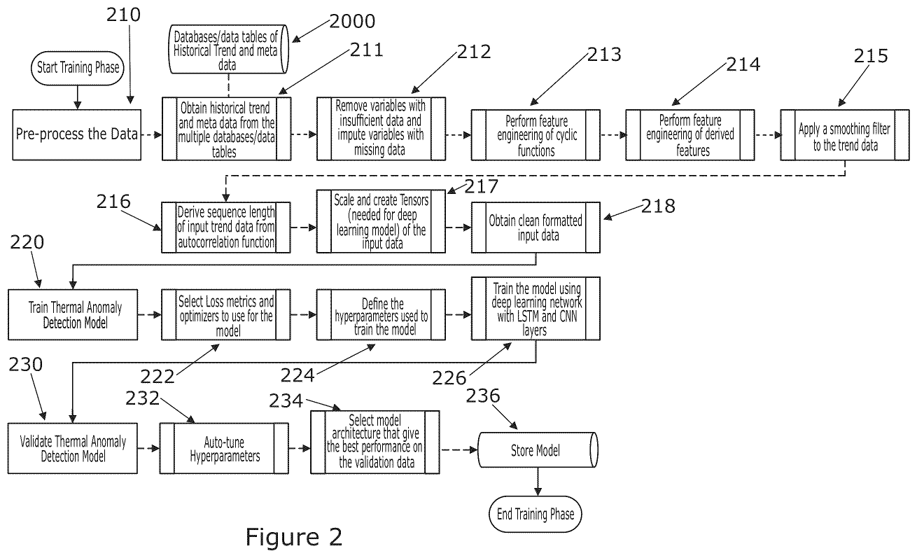

Once the architecture of the deep learning model is established, the model then has to be trained before use. The conventional approach to thermal anomaly detection involves one type of data—temperature measurement—but using this (or any other) one set of data is not adequate to enable causes to be determined. The approach taught in this disclosure does enable determination of causes, but to do this a variety of data is monitored (e.g. server temperature but also fan speed and data processing load) with complex causal relationships between them—it is therefore found to be necessary to adopt an approach that is effective for multivariate data. An appropriate approach for training such a model where the input involves multivariate data is illustrated in FIG. 2.

The first stage 210 is to pre-process the data so that it is in a suitable format for training. The first step is to extract 211 the data from the various data sources 2000 including databases and data tables—this includes historical trend data and metadata. Variables with insufficient data are removed, and the data is rendered clean and complete 212 by imputing values for any missing data. This can be done using standard imputation techniques (e.g. mean substitution, forward or backward fill, etc.). In the case of a physical environment such as a computer room, there will typically be some seasonality and other cyclicity (such as variation across a day) in “normal” data. This seasonality and cyclicity can be recognised 213 by using a combination of autocorrelation and frequency decomposition analysis. In this way, the seasonality of the data for individual continuous variables can be identified and associated cyclic features can be added as additional features. Using such autocorrelation and partial autocorrelation functions, the sequence length of the input temporal data can also be derived. Further feature engineering can also be performed 214 to identify and add potential additional derived features (e.g. heat generation, entropy, specific heat, etc.) using the physics of the system, as this may also be useful for thermal anomaly detection. Noise in the individual continuous variables data can be reduced 215 by applying a smoothing filter to the temporal data. If not done previously in the cyclicity recognition step 213, an autocorrelation function is used 216 to derive a sequence length of input trend data. Note that for temporal data to be correlated, a sequence of points is needed to capture seasonality rather than a single value—for example, for data with daily seasonality, prediction at any time instance would depend on values observed a day before but may also include values a few time steps before. The autocorrelation function will generate sequences effective to capture this. Finally, to make sure that the input data used for the training of the model is in the required format, this sequence length is used to scale the data and tensors are created to provide a representation 217 of the input data in a form that the deep learning model can use. In this way clean formatted input data 218 can be obtained.

The next stage 220 is to train the thermal anomaly detection model. As previously indicated, this model is an unsupervised deep learning-based model (for example, AE, VAE or GAN) incorporating both recurrent and convolution layers, which enables it to learn the temporal and non-temporal patterns of the input data. Firstly, the loss function (e.g. mean absolute error) to be used for validation, along with the optimizer (e.g. Adam Optimizer) to be used to train the model, is selected 222. Following this, the hyperparameters (e.g. number of epochs, number of hidden layers, number of nodes, activation function, batch size, etc.) for training the model are defined 224. Here the model may for example have LSTM (Long Short-Term Memory) and/or CNN (Convoluted Neural Network) layers. The model can now be trained 226 in a conventional way for a neural network, which will be a familiar process for the person skilled in the art.

This provides a thermal anomaly detection model, but this model now needs to be validated 230 before use. The hyperparameters may then be tuned automatically 232, using a grid search algorithm, and the model architecture that gives the best performance 234 (i.e. lowest validation loss) on the validation data is selected. The selected model is stored 236, and this ends the training phase.

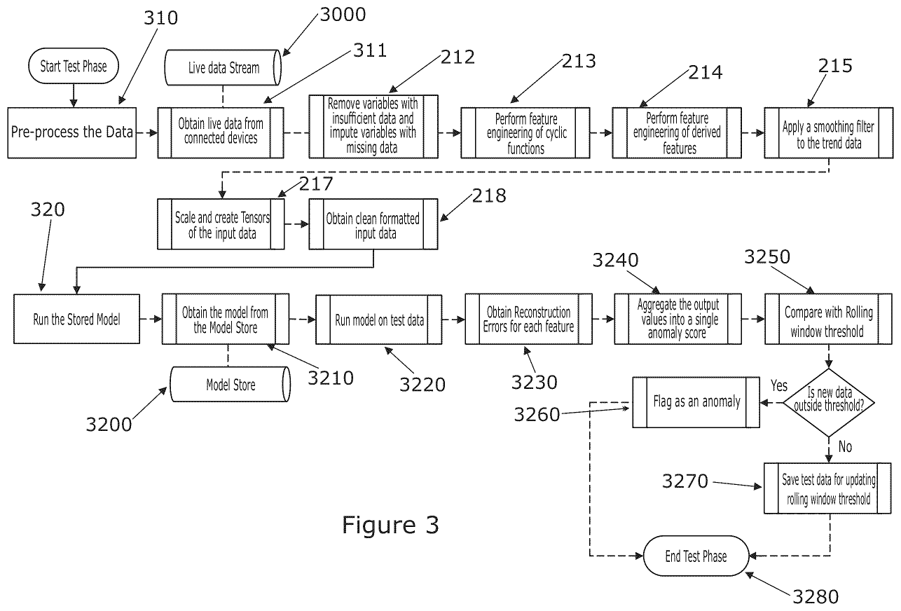

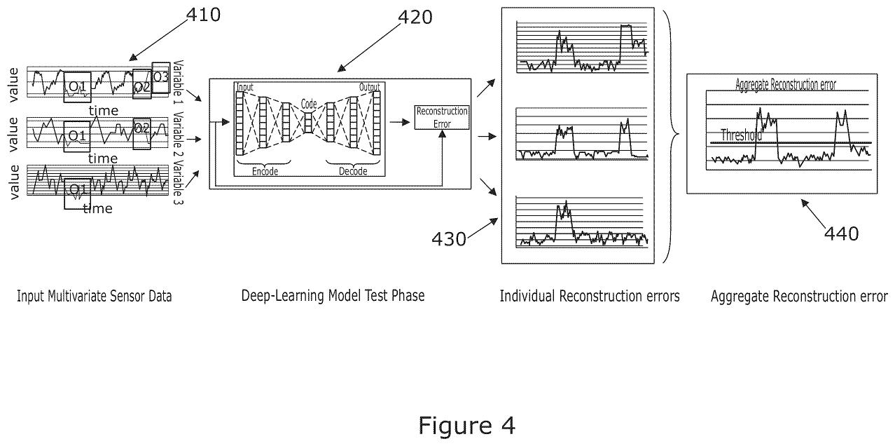

Once training of the model is complete, the model can be deployed and used to determine if new incoming data—test data—represents a thermal anomaly or not. A method used to accomplish this is set out in FIG. 3 and a representation of the results of this method at different stages of the process set out in FIG. 4.

As for the training phase, the test phase begins 310 with the pre-processing of data in essentially the same way as for the training data (steps are numbered correspondingly with those in FIG. 2), though in this case working from a live data stream 3000 with live data obtained 311 from connected devices, rather than the historical data used before. The stored model is run 320 in the following way:
The model is obtained 3210 from the model store 3200;
The stored model is run 3220 using test data.
Reconstruction errors for each feature—errors for the individual input variables, a distance metric of the difference between the individual input sequences and output sequences—are obtained 3230.
An aggregation of the reconstruction errors is calculated (e.g. mean, sum, weighted mean, weighted sum etc.) to provide 3240 a single anomaly score;
This anomaly score is compared 3250 with a rolling window threshold-this rolling window threshold is calculated by taking the aggregated reconstruction errors from the last sequence length of non-anomalous test data and obtaining a threshold utilizing standard distribution techniques. (e.g. quantiles, 2 sigma deviation, etc.);
   If the value is outside the threshold, it is flagged as an anomaly 3260;
   If the data point is within the threshold, it is stored 3270 for use in calculating future threshold values; and
This completes 3280 the test process.

This process is illustrated graphically in FIG. 4. Input multivariate sensor data is input 410 into the model 420 and individual reconstruction errors are found 430. These individual reconstruction errors are then aggregated 440 to produce an aggregate reconstruction error, which if it exceeds a threshold 445, is flagged as an anomaly.

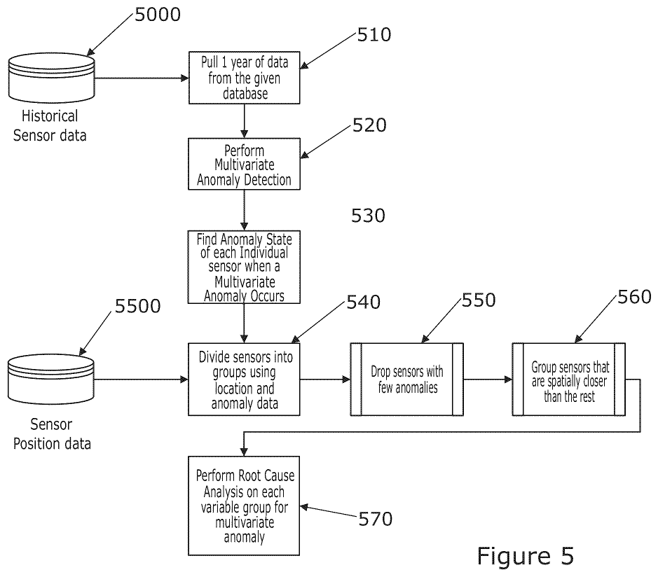

The next module conducts performance optimization to allow effective root cause analysis of a flagged anomaly. This process is shown in FIG. 5, and it is directed to ensuring that only necessary data is used in root cause analysis. For convenient explanation of the process, it is illustrated as including the anomaly detection performed by the preceding module and the root cause analysis made by the succeeding one.

Historical sensor data is pulled 510 from the relevant database or databases 5000, and multivariate anomaly detection is performed 520 as previously described. The performance of individual sensors in relation to anomalies is now assessed 530—the anomaly magnitude of each sensor individually is calculated at points where a multivariate anomaly is detected after aggregating the reconstruction errors.

This data can be used together with stored sensor position data 5500 to divide the sensors into groups 540. This allows sensor data that is found to have little effect on the data—such as sensors with few anomalies—to be filtered out 550, and for sensor data that is very strongly correlated with other sensor data—typically sensors that are physically close to each other—to be grouped 560. This simplified data can be used as an input for the following process 560 of root cause analysis 570, which will consequently be carried out on each variable group for a multivariate anomaly.

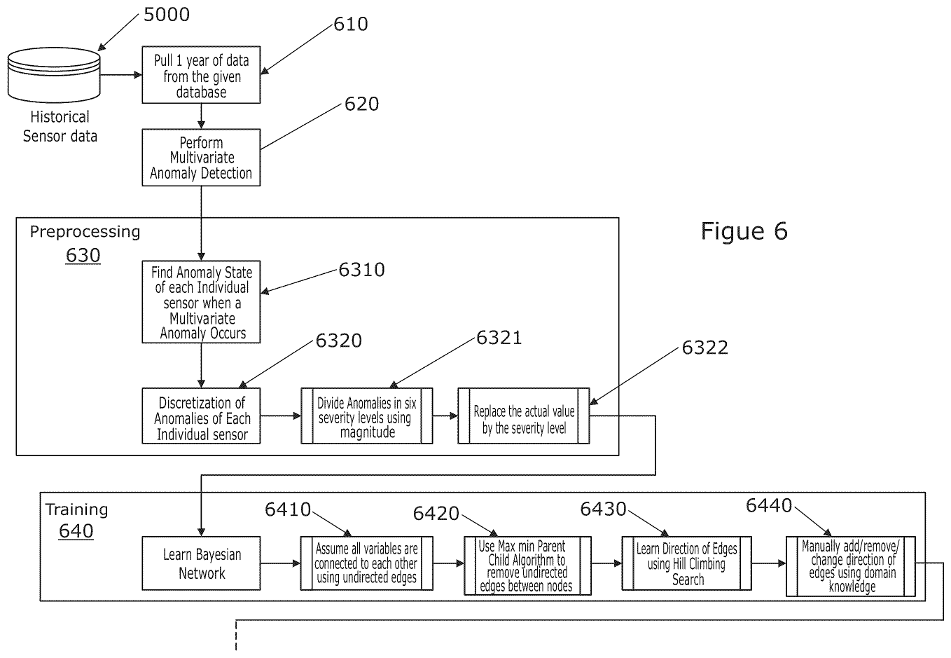

In a similar way to the deep learning model for multivariate detection, the root cause analysis model for an anomaly requires a pre-processing, a training and a testing phase. These are illustrated in FIG. 6. Rather than a neural network based deep learning model, the root cause analysis model uses a Bayesian network.

To provide data for training and testing, historical sensor data is pulled 610 from the relevant database or databases 5000 as before—in this example, a year's worth of data is taken—and multivariate anomaly detection 620 on this data is carried out as input to the pre-processing phase 630.

The pre-processing phase 630 is essentially directed to obtaining discrete data to describe anomalies from the time series data. First of all, the anomaly magnitude of each individual variable is calculated 6310 at points where a multivariate anomaly is found after aggregating reconstruction errors, using the output of the performance optimization engine. The multivariate anomaly and anomaly of each individual variable is discretized 6320—here, this is into various severity levels (six in the example) based on magnitude 6321, with the anomalous values from the time series data being replaced 6322 by the severity levels and the non-anomalous values are replaced by 0. The output of this phase is a discretized variable anomaly data including an additional variable for the multivariate anomaly, providing much more suitable starting input for a Bayesian network.

The training phase 640 which follows involves learning a Bayesian network. A Bayesian network (also known as a Bayes network, Bayes net, belief network, or decision network) is a probabilistic graphical model that represents a set of variables and their conditional dependencies via a directed acyclic graph (DAG). Bayesian networks are particularly suitable for taking an event that occurred and predicting the likelihood that any one of several possible known causes was the contributing factor (for example, in representing the probabilistic relationships between diseases and symptoms—given symptoms, a suitably developed network could be used to compute the probabilities of the presence of various diseases).

In this case, the Bayesian network is learned using a min-max hill climbing algorithm on the data obtained in the pre-processing step (other approaches are available for learning Bayesian networks—alternatives are discussed in Scutari, “Learning Bayesian Networks with the bnlearn R package” in Journal of Statistical Software, 10 Jul. 2010, foung at https://arxiv.org/pdf/0908.3817.pdf?fbclid=IwAR3onB3mMa5UdHPfBh). Initially, it is assumed 6410 that all variables are connected to each other. However, a max-min parent and child algorithm (see for example, Tsamardinos et al, “The max-min hill-climbing Bayesian network structure learning algorithm”, Machine Learning (2006) 65:31-78, found at https://link.springer.com/content/pdf/10.1007/s10994-006-6889-7.pdf) is used to remove 6420 edges between conditionally independent variables, so that the edges that remain represent some kind of dependency. A hill climbing search is then used 6430 to find direction of edges—domain knowledge can be used to add/remove/change 6440 this direction. In this way a score function can be optimized to establish the network.

Once the Bayesian network has been learned, the next stage is the testing phase 650 which involves the generation 6540 of the Causal Explanation Tree (CET). Additional user input 6510 is used at this point to supplement the Bayesian network—this comprises an explanandum to explain context and relationships and a threshold, which is a hyperparameter setting the depth of tree that can be created. From the start 6520 of the CET establishment process using inputs from these two sources, variables and the intervention path are initialized 6530. Variables include explanatory variables and observed variables. Explanatory variables are the variables which are relevant for explaining the anomalous event. In the presence of a domain expert, a subset of explanatory variables can be chosen for root cause analysis. Otherwise, all variables are utilised. Observed variables are the variables for which the state (anomaly or not anomaly) is known from measurement.

Generation of the CET 6540 uses the following approach (this is described in more detail in Nielsen et al, “Explanation Trees for Causal Bayesian Networks”, Proceedings of the Twenty-Fourth Conference in Artificial on Uncertainty Intelligence, found at https://arxiv.org/abs/1206.3276). First of all, an empty tree is initialised 6541, and then a variable X is found, where X maximises causal information flow with explanatory variables given the observed variable. This maximum causal information flow is measured 6542 against a threshold—if this is less than the threshold, then there simply is not a good enough probability of cause and an empty tree is returned 6543. If the threshold is met, a tree can be generated. This involves a loop, starting with an assessment 6544 of whether there is state in X that has not yet been added to the tree. If there is, a subtree of the following form is established 6545:
Subtree T′=Function (Explanatory set—X, Observation set, Explanandum, Path of Observation+x)
   and a branch is added 6546 between T and T′ with a contribution factor for this subtree. When there is no more contribution to add, the tree T is returned 6547. This tree can now be used to predict 6550 the root cause of an anomaly.

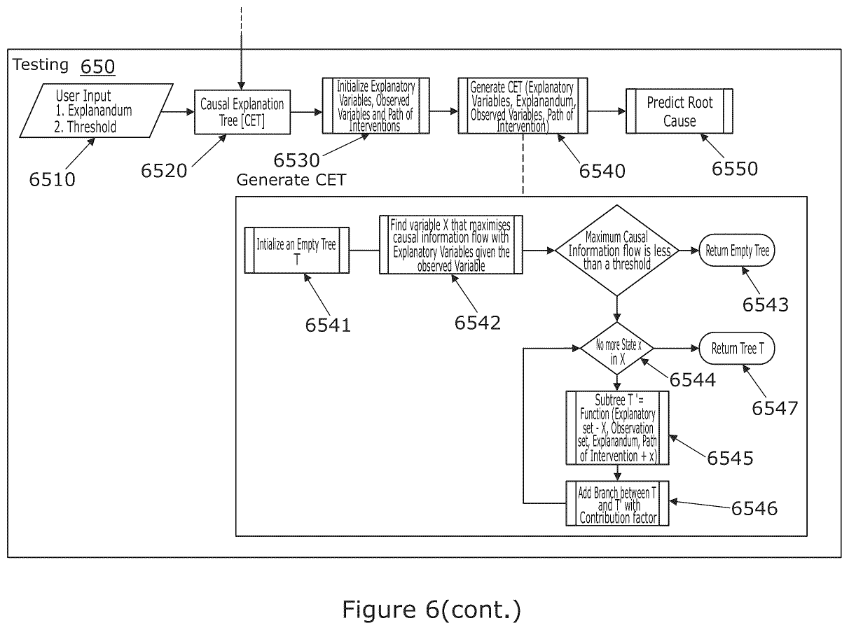

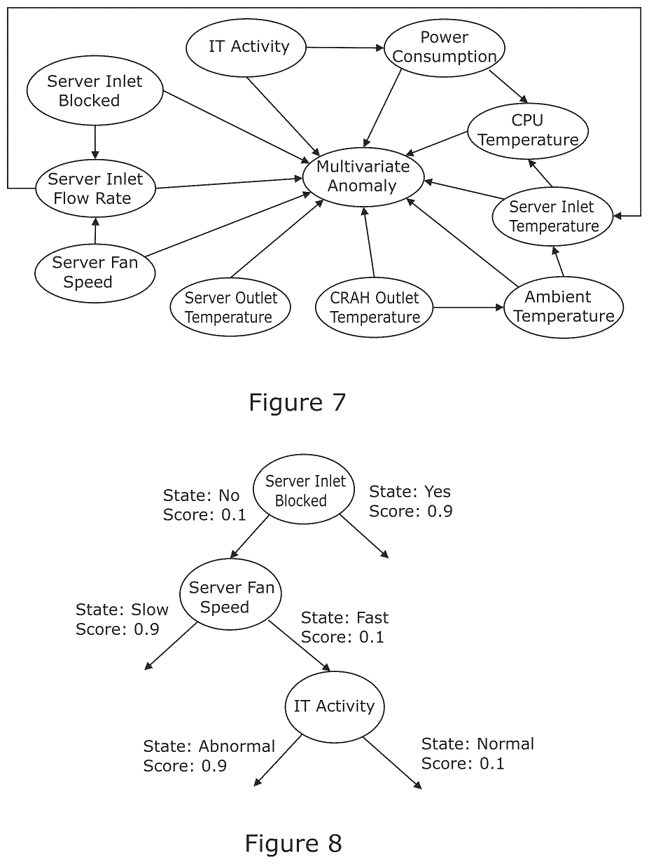

How this is done may be seen most easily from illustration. The state of the root node with the highest branch score gives the root cause of the multivariate thermal anomaly. For example, FIG. 7 shows a Bayesian network learned using data available in respect of a multivariate anomaly detected due to clogging of a server inlet causing a rise in temperature (a functional example discussed in Chen et al as mentioned above). This is observed to lead to an increase in fan speed. FIG. 8 shows the causal explanation tree following from this Bayesian network generated for the multivariate anomaly with a high severity as the explanandum. The root node “Server Inlet Blocked” with state “Yes” having a significantly higher score than state “No” gives the best explanation for the explanandum. However, this can be checked—if it is found that the state of “Server Inlet Blocked” is in fact “No”, then another explanation must be found. It can be seen from the CET that the next best explanation is “Server Fan Speed” having state “Slow” (with a significantly higher score than state “Fast”). If this is known not to be the cause—if we know that “Server Fan Speed” has state “Fast”—the next best explanation is “IT Activity” having state “Abnormal”.

Once the root causes of an anomaly is determined, it will preferably be communicated in real time to a relevant person or system using the alerting system 10. If to a person, this may be to their smart phone or computing apparatus through an appropriate interface—the alerting mechanism may request a particular action to be taken, may request further information, or may advise the user of remedial action being taken automatically. The user would be provided with a mechanism through the same interface to give feedback or other information to the system. In the case of feedback, this may be an indication of whether the alert is accurate or a false positive—if it is a false positive, this information can be used to retrain the model to perform better in future.

The skilled person will appreciate that the embodiments described above are exemplary, and that further embodiments may be provided within the spirit and scope of the disclosure. In particular, this approach is not limited to use for determining thermal anomalies in data centres, but that it has application to a wider set of environments, and potentially also to a broader class of problems.

1. A computer-implemented method of managing thermal anomalies in an environment, the method comprising:
training a deep learning system to identify thermal anomalies from recorded environment parameter data;
training a Bayesian network to identify relationships between environment parameters, and generating a causal explanation tree from the identified relationships; and
measuring environment parameters in the environment to identify a thermal anomaly, and on identification of the thermal anomaly, using the causal explanation tree to predict the root cause of the thermal anomaly.

2. The method as claimed in claim 1, wherein the environmental parameters are of multiple parameter types, and wherein the multiple parameter types include thermal measurements in the environment and at least one more parameter type.

3. (canceled)

4. The method as claimed in claim 2, wherein the at least one more parameter type comprises one or more of cooling equipment status, cooling equipment performance and power usage in the environment.

5. The method as claimed in claim 1, wherein the environmental parameters comprise one or more parameters with temporal cyclicity.

6. The method as claimed in claim 5, wherein said one or more parameters are represented by a time varying sequence of values determined using an autocorrelation function.

7. (canceled)

8. The method as claimed in claim 1, further comprising a performance optimization stage between identification of the thermal anomaly and providing a causal explanation of the thermal anomaly, wherein providing the causal explanation of the thermal anomaly uses only necessary environment parameter data to provide the causal explanation; and wherein the performance optimization stage is performed both before training of the Bayesian network and development of the causal explanation tree and before using the causal explanation tree to predict the root cause of the detected thermal anomaly.

9. (canceled)

10. The method as claimed in claim 1, wherein the deep learning system comprises one or more neural networks, and wherein the deep learning system comprises an autoencoder, a variational autoencoder, or a generative adversarial network.

11. (canceled)

12. The method as claimed in claim 1, further comprising providing an alert on detection of the thermal anomaly.

13. The method as claimed in claim 12, wherein the alert is provided with the causal explanation tree for the detected thermal anomaly to one or more recipients by a network connection.

14. (canceled)

15. The method as claimed in claim 13, wherein the environmental parameters are of multiple parameter types and the multiple parameter types include thermal measurements in the environment and at least one more parameter type; and wherein the at least one more parameter type comprises server load and/or server performance.

16. A thermal anomaly management system for managing thermal anomalies in an environment, the thermal anomaly management system comprising:
means to receive environment parameter data for a plurality of environment parameters for the environment;
a computing system having at least one memory and a processor programmed to provide at least:
a deep learning system trained from recorded environment parameter data to identify thermal anomalies;
a Bayesian network trained to identify relationships between environment parameters; and
a causal explanation tree developed from the identified relationships; and
using, on identification of a thermal anomaly from received environment parameter data, the causal explanation tree to predict a root cause of the thermal anomaly.

17. The thermal anomaly management system of claim 16, wherein the means to receive environment parameter data comprises a plurality of sensors in the environment.

18. The thermal anomaly management system of claim 17, wherein the plurality of sensors comprises temperature sensors.

19. The thermal anomaly management system of claim 16, wherein the environmental parameters are of multiple parameter types, including thermal measurements in the environment and at least one more parameter type.

20. The thermal anomaly management system of claim 19, wherein the at least one more parameter type comprises one or more of cooling equipment status, cooling equipment performance and power usage in the environment.

21. The thermal anomaly management system of claim 16, wherein the computing system further comprises a performance optimization stage between identification of the thermal anomaly and providing the causal explanation tree of the thermal anomaly adapted so that only necessary environment parameter data is used to provide the causal explanation tree.

22. The thermal anomaly management system of claim 16, wherein the deep learning system comprises one or more neural networks; and wherein the deep learning system comprises an autoencoder, a variational autoencoder, or a generative adversarial network.

23. (canceled)

24. The thermal anomaly management system of any of claim 16, further comprising an alerting system for providing an alert on detection of the thermal anomaly.

25. The thermal anomaly management system of claim 24, wherein the alerting system is adapted to provide the alert with the causal explanation tree for the detected thermal anomaly to one or more recipients by a network connection.

26. The thermal anomaly management system of claim 16, wherein the environment is a data centre or a server room.
